(19) United States
(12) Patent Application Publication
(10) Pub. No.: US 2005/0256232 A1
(43) Pub. Date: Nov. 17, 2005

(54) Fluidized polymer suspension including polyethylene glycol, organoclay, and water-soluble polymer

(76) Inventors: Louis D. Walsh, Peachtree City, GA (US); Kenneth McKenzie, Atlanta, GA (US); Ilkka K. Tamminen, Peachtree City, GA (US); Jukka K. Lehtovuori, Aanekoski (FI)

Correspondence Address: Carlos Nieves, Esq.;J.M. Huber Corporation, Law Department, 333 Thornall Street, Edison, NJ, 08837, US

(21) Appl. No.: 10/846,914

(22) Filed: May 17, 2004

(51) Int. Cl. C08L 1/00

(52) U.S. Cl. 524/35; 524/55; 524/44; 524/45; 524/445; 524/447; 524/425

(57) ABSTRACT

A nonaqueous fluidized polymer suspension containing at least one water-soluble polymer, low molecular weight polyethylene glycol, an optional dissolution additive, and at least one organoclay suspending aid to permit effective long-term, uniform, storage-stable fluidizing of the polymer is provided. Such a novel suspension permits the delivery of the water-soluble polymer as an additive or within a coating for certain substrates in liquid form, when such a component is normally present as a solid, in order to impart excellent fluidity characteristics to the polymer formulation. Such a fluidized polymer suspension exhibits ease-of-use through low suspension viscosity, provides easier handling of such a polymer (in liquid rather than in solid form), provides low environmental toxicity and low volatile organic content, and also permits beneficial treatment of certain substrates with the water-soluble polymer as well as simultaneous treatment thereof with both the polymer and the low molecular weight polyethylene glycol. The inventive fluidized polymer suspension provides excellent delivery capabilities of desirable additives for paper coating compositions, as well as within paint formulations. Suspension-treated paper substrates are also encompassed within this invention, as is the method of producing such a unique suspension.

### FIELD OF THE INVENTION

This invention relates to a nonaqueous fluidized polymer suspension containing at least one water-soluble polymer, low molecular weight polyethylene glycol, an optional dissolution additive, and at least one organoclay suspending aid to permit effective long-term, uniform, storage-stable fluidizing of the polymer. Such a novel suspension permits the delivery of the water-soluble polymer as an additive or within a coating for certain substrates in liquid form, when such a component is normally present as a solid, in order to impart excellent fluidity characteristics to the polymer formulation. Such a fluidized polymer suspension exhibits ease-of-use through low suspension viscosity, provides easier handling of such a polymer (in liquid rather than in solid form), provides low environmental toxicity and low volatile organic content, and also permits beneficial treatment of certain substrates with the water-soluble polymer as well as simultaneous treatment thereof with both the polymer and the low molecular weight polyethylene glycol. The inventive fluidized polymer suspension provides excellent delivery capabilities of desirable additives for paper coating compositions, as well as within paint formulations. Suspension-treated paper substrates are also encompassed within this invention, as is the method of producing such a unique suspension.

### BACKGROUND OF THE INVENTION

Water-soluble polymers, such as certain cellulosic-based types (carboxymethylcellulose, as one non-limiting example), have been utilized within numerous fields for many years as viscosity modifiers, carriers, anti-redeposition agents, and other like purposes within the paper, oil, food, paint, and detergent industries, to name a few. In particular, the utilization of certain water-soluble polymers as additives for coatings of paper substrates has been preferable for many years. Polymers such as carboxymethylcellulose impart excellent water retention properties to paper, permit high shear coating at very high speeds of such substrates, exhibit excellent rheological properties for coating applications, permit simultaneous lubrication of coating blades during coating applications at high speeds, and provide compatibility with other paper substrate additives. Unfortunately, the delivery of such polymers has proven difficult to a certain extent due to a number of diverse reasons. For instance, such polymers are generally present as dry powders, the handling of which often causes dusting which has been known to lead to certain health and safety problems. Moreover, in the case of carboxymethylcellulose and other like polymers, the dusting problem is particularly troublesome, because these materials tend to undesirably adhere strongly to certain surfaces, thereby making regulation during manufacture and use thereof imperative, leading to increases in associated costs. Furthermore, such particulate water-soluble polymers are difficult to properly dissolve within aqueous media without either gelling or creating hard-to-correct coagulation therein. In either situation, the ability to provide a uniform well-dissolved aqueous formulation including such desirable water-soluble polymers has been difficult to produce reliably. Thus, effective and uniform dispersion of such materials is highly desired to permit more reliable substrate treatment at lower costs and with more effective treatment results.

Of particular interest is the facilitation of use of such water-soluble polymers within systems that have very little, if any, water present for polymer hydration (such as within certain pigment-containing formulations, for example). For paper processing, at least, such pigment-containing formulations generally exhibit a pigment level of about 70% solids content, a binder level of sufficient amount to permit proper contact and reaction between the pigment and the paper surface, and the remainder water. The low amount of water is very difficult to extract for polymer hydration upon mixture with a water-soluble polymer (for example, carboxymethylcellulose, as above); the pigment component does not easily donate any bound water present therein. Thus, the ability to provide an effective fluidized polymer for such low available water additive-containing formulations is necessary to the extent that the low amount of water present is not required for proper polymer hydration during processing. It has been realized that such low available free water materials, at least those that would benefit from the addition and/or presence of such water-soluble polymers for myriad reasons, will function better when certain nonaqueous additives are incorporated therewith; however, the ability to provide such a proper nonaqueous water-soluble polymer (carboxyalkylcellulose-types, for instance) dispersion has not been forthcoming within the pertinent paper and/or paint industries.

Certain fluidized water-soluble polymer dispersions have been attempted in the past, but have all failed to a certain degree to provide overall effective results, particularly within the paper coating industry. For instance, carboxymethylcellulose in water alone thickens much too quickly to permit effective coating on a uniform basis. Thus, other additives, particularly nonaqueous-based, were required. Mixed alone with such vehicles (for example, polyethylene glycol, mineral oil, and the like) resulted in likewise ineffective results, both from a uniform coating aspect (phase separation was experienced in some instances while high volatile organic content, or, alternatively, toxicity to unacceptable levels, existed as well). Other formulations were tried with other aqueous- and nonaqueous-based solvents; however, the results were unacceptable as well as the formulation thickened to too great a degree to be useful. Beyond those disappointments, some formulations appeared, at first, at least to permit effective dispersion, uniform coating capabilities, and low toxicity and/or volatile organic content. Unfortunately, such further attempts exhibited a noticeable lack of long-term storage stability, thereby either requiring formulation very soon to actual utilization, or expensive, potentially unreliable mixing at the paper coating site to redisperse the water-soluble polymer to the degree needed. Such newer formulations included polyethylene glycol mixed with hydroxyethyl cellulose alone, or with carboxymethylcellulose included as well. It has thus proven difficult to provide an effective fluidized polymer dispersion for the paper coating industry that meets the critical and delicate requirements associated therewith.

Furthermore, the ability to simultaneously provide formulations of such polymers with other preferable materials for proper coating and substrate treatment is highly desired, but, to date, unavailable, at least within nonaqueous-based formulations. For example, polyethylene glycol is known to impart highly desired properties to paper substrates, such as plasticity and gloss increases to finished paper surfaces, as ointment and lotion bases for skin, within cosmetic and toiletry compositions, on ceramic surfaces, within paint formulations, and other hydrophobic types of substrates; unfortunately, in order to permit proper treatment therewith, there has been great difficulty in applying such a material with the above-described water-soluble polymers (which also provide effective and desirable characteristics on the same types of substrates). Coexistent treatments with such components have been unavailable such that prior attempts at treatment required an initial coating with one material followed subsequently by the other. In such a manner, the resultant substrate does not receive the complete treatment desired of both components.

Prior attempts at fluidizing water-soluble polymers (such as, for one nonlimiting broad example, carboxyalkylcellulose types) have resulted in the utilization of undesirable suspending aids for such a purpose. For example, U.S. Pat. No. 4,799,962 to Ahmed discloses particulate water-soluble polymers dispersed in liquid medium comprised of low molecular weight polyethylene glycol, water and high molecular weight polyethylene glycol. In such a dispersion, the high molecular weight PEG permits suspension of the polymer within the lower molecular weight species. This resultant nonaqueous suspension exhibits certain drawbacks in terms of versatility, at least.

Furthermore, U.S. Pat. No. 5,096,490 to Burdick describes a polymer/fatty acid fluid suspension, in particular, the invention relates to polymers such as CMC suspended in a fatty acid. Such a suspension with fatty acids does not impart the added benefits of PEG and exhibits suspect dispersion stability. Additionally, U.S. Pat. No. 5,932,193 to Lopez et. al. discloses a toothpaste composition comprising dental abrasive, humectants, and a fluidized polymer suspension. The fluidized polymer suspension comprises polyethylene glycol, carboxymethyl cellulose, and a hydrated thickening silica. Such a composition does not easily dissolve in high solids or low available water coating formulations, and thus limits the potential usefulness thereof.

These and other prior art teachings exhibit noticeable problems for the highly desired practice of adding such a water-soluble carboxyalkylcellulose polymer in liquid form within a low available free water system, not to mention certain stability, toxicity, and overall VOC content issues. As such, to date, there is a lack of teaching or fair suggestion of any fluidized carboxyalkylcellulose-containing formulation that meets all such target results, only individual or some of these desirable benefits. With such in mind, it has now been determined that such beneficial formulations are available through the incorporation of particularly selected additives.

### BRIEF DESCRIPTION AND OBJECTS OF THE INVENTION

Water-soluble polymers are used to retain water, thicken aqueous solutions, bind materials, suspend formulation components, stabilize compositions, and permit more effective pigment absorption to target substrates. The application for these products is widespread and includes, without limitation, food additives, pharmaceutical components, personal care additives, paper coatings, paints, drilling fluid aids, and many other industrial applications. As noted above, the ability to provide aqueous-based fluidized formulations of such polymers are particularly desirable due to the avoidance of toxic solvents and high volatile organic content levels at least.

Water-soluble polymer dispersions exhibit a number of advantages over their powder versions. Among these advantages is ease of handling and quicker dissolution within added-to formulations as compared to powdered water-soluble polymers. However, one drawback to fluidized water-soluble polymers has always been the standard requirement of high polymer loading; in such an instance, it has been realized that the addition of water too quickly or after improper storage can result in unwanted gel formation. Such gels are very difficult to dissolve properly without costly and potentially unreliable long-duration mixing and thus should be avoided in order to ensure the suspension imparts uniform treatment and appearance within the target composition or on the target substrate. The prior art fluidized systems noted above utilized certain undesirable carriers, too high viscosity, or produced low long-term storage stability products that compromised the effectiveness and/or reliability of the ultimate water-soluble polymer formulations. As such, there was a clear need to provide a non-aqueous-based system that exhibited proper storage stability and effective dissolution upon subsequent introduction within target formulations (particularly, though by no means intended as limiting, water-starved systems).

Accordingly, it is one object of the present invention to provide a storage stable fluidized water-soluble polymer suspension. Another object of the present invention is to provide such a fluidized polymer suspension including polyethylene glycol in order to permit utility of such a suspension for a plethora of different applications for which both components are desired.

Accordingly, this invention encompasses a novel fluidized polymer-containing suspension comprising at least one water-soluble polymer, low molecular weight polyethylene glycol (e.g., having a molecular weight of at most about 600), an optional dissolution additive, and at least one suspending aid (such as, without limitation, an organoclay additive). Also encompassed within this invention is a method for producing such a suspension, said method comprising the sequential steps of a) providing a low molecular weight polyethylene glycol; b) mixing therewith at least one suspending aid (again, as one non-limiting example, an organoclay additive) via high shear blending; c) adding at most 5% by weight of the total mixture of polyethylene glycol and suspending aid of water (whereby the water acts as an activator to permit suspending aid swelling prior to addition of the water-soluble polymer, thereby preventing eventual polymer swelling of such an important component therein); d) adding, if desired, a dissolution additive (such as a lubricant or surfactant, dicussed in greater detail below); e) introducing the water-soluble polymer to the resultant mixture; and f) thoroughly mixing the resultant mixture of step “e” to produce a suspension. Also encompassed within this invention is a substrate coated with such a suspension, as well as a liquid formulation to which such a suspension has been added.

It is imperative that the inventive fluidized polymer suspension exhibits storage stability for long periods of time. Hence, such a suspension must therefore not exhibit separation into two or more distinct layers when standing, whether once made or upon long-term storage at room temperature and pressure (i.e., 20-25° C. and 1 atmosphere pressure). The long-term viability of such a suspension should last at least 30 days under such conditions, up to the typical time such a suspension will be utilized by a manufacturer (anywhere from 3 to 12 months). Reliability of proper stability is necessary in order to provide the needed effective dispersability upon demand.

It is this reliability for a nonaqueous fluidized water-soluble polymer suspension that has unexpectedly been discovered within this invention through the utilization of a self-activating swellable organoclay additive within a low molecular weight polyethylene glycol system. Prior attempts at nonaqueous suspensions have been unsuccessful due to the problems inherent with introducing water with water-soluble polymers (such as carboxyalkylcellulose types, carboxymethylcellulose being one non-limiting example thereof), as noted previously. The avoidance of the prior required nonaqueous solvents and the necessary inclusion of a swelled (activated) organoclay suspending aid permit greater environmental acceptance, and, surprisingly, provide effective and acceptable stability, when a proper suspending aid is selected for incorporation therein. As such, this inventive suspension accords great versatility to the user in terms of selecting the proper time to introduce such a water-soluble polymer or polymer plus co-additive polyethylene glycol to and/or within target formulations or on selected substrates for treatment, all with a low toxicity, low VOC content, uniformly dispersed suspension heretofore unavailable within the industry.

One other significant issue resolved through utilization of this suspension is the ability to introduce such desirable water-soluble polymers within water-starved (e.g., high pigment-loaded) systems and compositions without appreciable deleterious results. As noted previously, pigments and such compositions comprising such materials require water for proper dispersion and thus ultimate utilization. Thus, introduction of any additives that effectively compete with such water-starved pigments (i.e., water-soluble polymers that, by themselves, attract moisture in significant amounts and at high rates due to raised hydrophilicity) for water, moisture, etc., within certain systems, formulations, and the like, would most likely compromise the effectiveness of such pigment components therein. Thus, it has been extremely difficult to provide such a desirable, yet highly hydrophilic water-soluble polymer additive within water-starved formulations without deleteriously affecting the performance of the base compounds (such as, again, pigments, although other components may be present as water-starved materials as well). The ability to provide such a nonaqueous fluidized polymer suspension to overcome this deficiency (with low VOC content, low volatility, long-term storage stability, etc.) has finally been met with this invention. Such inventive fluidized polymers permit a greater capability for dissolution within such pigment-based systems. Generally, such pigment suspensions prove difficult to dissolve and/or do not easily permit dissolution of water-soluble polymer/low molecular weight polyethylene glycol suspensions to dissolve therein. Such a problem has been overcome as well through the development of the inventive materials.

### DETAILED DESCRIPTION OF THE INVENTION

Polyethylene glycol, also called “polyoxyethylene”, “poly(ethylene oxide)”, or “polyglycol” is a well known condensation product of ethylene glycol having the formula H(OCH₂CH₂—)ₙ—OH (wherein n is from about 10 to about 50, and thus is a low molecular weight compound of at most 600). “Low molecular weight polyethylene glycol” is typically considered having a molecular weight range from about 100 to 700 and more preferably for this invention between 200 and 400 (polyethylene glycol is a liquid between the ranges of 200 to 600 and becomes a waxy-white soft solid between 900 and 1450, and a hard waxy-white solid from 3350 to 8000). These products are commercially available under the Dow trade name “Carbowax”. Such components provide the advantage of very low volatility and excellent thermal stability. For the inventive suspension, the low molecular weight polyethylene glycol component is present in an amount of from about 20 to about 75% by weight of the total suspension; preferably from about 30-70%; more preferably from about 40-65%; and most preferably from about 55-65%. Although such a low molecular weight polyethylene glycol is required, a certain amount of such a component may be substituted with another water-soluble additive, up to, at most 20% of the total weight of the composition. Such substitute ingredients include mineral oil, calcium carbonate pigment, kaolin pigment, or any mixtures thereof. The low-molecular weight polyethylene glycol, besides imparting certain characteristics to target surfaces and substrates, also helps protect the water-soluble polymer from premature water exposure. Such a component is highly hygroscopic, exhibits very low environmental VOC and toxicity, and makes an excellent carrier for the water-soluble polymer, particularly for eventual utilization on paper substrates that require glossy properties imparted thereto. The presence of any polyethylene glycol in excess of a molecular weight of 600 is discouraged because of the lower hygroscopic nature thereof, and the difficulty in properly suspending a highly hygroscopic water-soluble polymer therein for long periods of time. The low molecular weight of the polyethylene glycol is thus of great importance to the proper functioning of the overall fluidized suspension.

In the fluidized polymer suspensions of the invention, the water-soluble polymer component is any type that is essentially nonionic or anionic in nature. Within this class are cellulosic types, such as sodium carboxymethyl cellulose (CMC), hydroxyethyl cellulose (HEC), ethyl hydroxyethyl cellulose (EHEC) carboxymethylhydroxyethyl cellulose (CMHEC), hydrophobically modified hydroxyethyl cellulose (HMHEC), methyl cellulose (MC), and hydroxypropyl methyl cellulose (HPMC), as well as gum types, such as guar, hydroxypropyl guar, xanthan gum, carrageenan, gum arabic, alginates, pectin, alginate, and tara gum. Preferred are the cellulosics (for cost purposes), most preferably sodium carboxymethylcellulose (such as FINNFIX®, available from Noviant). Such a water-soluble polymer or polymers are preferably present within the inventive suspension in an amount from about 10 to about 65 wt. % of the total weight of the fluidized polymer suspension. More preferably the water-soluble polymer is present from about 15 to about 60 wt. % and most preferably from about 20 to about 50 wt. %.

The other ingredient necessary in the fluidized polymer suspensions of the invention is a suspending aid, which will generally be present at a level of from about 0.5 to about 3 wt. % of the total weight of the suspension. The stabilizing agents are organic or inorganic materials which can be dispersed or dissolved in the polyethylene glycol vehicle and that exhibit appreciable swelling upon activation with water in order to properly thicken the initial suspension medium to prevent settling of the subsequently introduced water-soluble polymer. This settling prevention permits a substantially uniform blending of the polymer constituent within the polyethylene glycol base. The selection of suspending aid is thus of critical importance to the proper functioning of the ultimate inventive suspension since the avoidance of volatile or low thermally stable solvents is provided and effective mixing with water is permitted without unwanted gelling or coagulation of the polymer therein due to the presence of such a component.

Preferred suspending aids are organoclays that are self-activating organoclays of the bentonite type, such as those provided by Rheox (under the tradename BENTONE®), Southern Clay Products (under the tradename CLAYTONE®), Sud-Chemie (TIXOGEL®), and Baroid (GELTONE®). These self-activating clays are essentially rheological additives of “organically modified” clays produced by reacting organic cations, such as quaternary ammonium chlorides, with bentonite.

The most preferred of these organoclays is Claytone® APA, a finely divided powder clay exhibiting a Bulk Density of 37 lbs/ft³.

The term “self-activating organoclays” connotes the ability to provide suspension characteristics without needing a polar activator (for example, methanol in water, ethanol in water, propylene carbonate). Such “self-activating organoclays” generally only require high shear and/or heat for activation, although water by itself provides an expectedly effective and significant boost in this capability as well.

In the present invention, the preferred organoclay (preferably CLAYTONE® from Southern Clay Products) is present from about 0.1-5.0% by weight based on the total weight of the suspension, more preferably from about 2.0-4.0% by weight.

The inventive fluidized polymer suspensions will also contain water in order to provide additional activation to the suspending aid. The amount is from about 0.01 to about 5% by weight of the total suspension. Although there is water present in order to effectuate such swelling of the suspending aid, the availability of water from such a fluidized polymer for utilization outside the system is nonexistent. Thus, the term “nonaqueous” is satisfied as it applies to the fluidized polymer formulation itself since this added water functions entirely in such a activating capacity.

As alluded to above, the method of production of such an inventive suspension requires specific steps in order to ensure the desired results in terms of uniform, long-term stable water-soluble polymer dispersion are met.

In certain circumstances, production of such a suspension of a water-soluble polymer suspension in polyethylene glycol can become somewhat problematic such that a dissolution aid is needed in the form of a surfactant, lubricant, or other like material. Such a potential problem becomes more pronounced when the water-soluble polymer is initially added as a finely ground particulate solid (the higher the surface area, the greater propensity for moisture adherence to exist, thereby possibly creating gelling issues). In terms of the main components themselves, water-soluble polymers are generally very hydrophilic and the low molecular weight polyethylene glycol is also hydrophilic. The water solubility is highest for the lowest molecular weight polyethylene glycol (e.g., average molecular weight of 200) that decreases as molecular weight increases. The ability to, as noted above with the suspension aid, delay hydration of the water-soluble polymer until the suspension itself is initiated thus permits production of the desired resultant inventive suspension. Surfactants (of any type, preferably nonionic, however, in configuration) thus facilitate dissolution within the polyethylene glycol base by allowing the polymer to disperse before starting to hydrate, especially in high solids water starved systems. Potentially preferred are those that are C₁₂-C₂₄ fatty acid salts, such as alkali metal or alkaline earth metal stearates, including, without limitation, calcium stearate, magnesium stearate, sodium stearate, lithium stearate, barium stearate, zinc stearate, aluminum stearate, or any mixtures thereof. Most preferred is calcium stearate for such a purpose. Such an additive may be introduced in an amount of from about 1 to about 20% by weight of the total composition; preferably from about 1 to about 15% by weight. Such a component actually imparts the benefits of protecting the water-soluble polymer from premature exposure to water, in addition to the hygroscopic nature of the low molecular weight polyethylene glycol. In such a fashion, the extra protection provided by the dissolution aid (preferably calcium stearate, due to its compatibility with various paper coating materials) allows for greater long-term stability of the fluidized polymer as a suspension during storage. The ability to prolong water exposure, or at least drastically limit such water exposure of the water-soluble polymer component, permits effective dissolution within the target application formulation and thus ultimate effectiveness on the desired substrate. If the water-soluble polymer exhibits premature exposure to sufficient amounts of water, as noted previously, such materials will coagulate together, thereby preventing proper dissolution within a target formulation or on a target substrate. The ability to prevent such coagulation coupled with the simultaneous application of a desired co-additive (namely low molecular weight polyethylene glycol) thus accords the user a highly desirable delivery system for such components for, at least, the paper coating industry.

Further additives that may be introduced within the inventive fluidized polymer include crosslinkers, optical brighteners, antimicrobials, detergents, softeners, and any combinations thereof.

The particular method for producing such an inventive suspension is as follows: said method comprising the sequential steps of a) providing a low molecular weight polyethylene glycol; b) mixing therewith at least one organoclay suspending aid via high shear blending (e.g., using a Waring mixer having a variable speed propeller, at from 15,000 to 30,000 rpms); c) adding at most 5% of the total weight of the resultant mixture of step “b” of water (whereby the water acts as an activator to permit suspending aid swelling prior to addition of the water-soluble polymer; d) adding a dissolution additive (such as a lubricant or surfactant, discussed in greater detail below); e) introducing the water-soluble polymer to the resultant mixture; and f) thoroughly mixing the resultant mixture of step “e” to produce a suspension. The mixing step “b” generally requires a mid- to high-speed (1000 to 2000 rpm range) apparatus such that after from about 15 seconds to about 5 minutes time, the suspending aid is thoroughly mixed within the polyethylene glycol base. A small amount of water (again, at most 5% of the total weight of the resultant mixture of PEG and suspending aid) is then added for activation to the resultant mixture and the new mixture is then mixed in much the same manner as in step “b”. Likewise, the dissolution additive of step “d” is introduced and mixed similarly. Finally, the water-soluble polymer is added and thoroughly mixed at 1,000 to 2,000 rpms) for from about 1 to about 20 minutes to permit production of the ultimate suspension in reliable fashion for uniformity and storage stability. This method prevents hydration of the polymer appreciably until ultimate contact with water or incorporation within a composition, thereby allowing the polymer to remain in a suitable low viscosity state for proper mixing and utilization.

The fluidized polymer suspensions of this invention find use in myriad end-use formulations, but particularly within paper coating and paint compositions.

Such paper coating formulations comprise the inventive fluidized polymer suspension and are then applied to paper substrates. Other active materials can be applied to the same paper substrate in order to accord other benefits thereto. A variety of such other active materials include surfactants; pigments or other type of colorant; antioxidants; emulsifiers; opacifiers; pearlescent aids such as ethylene glycol distearate, or TiO₂ coated mica; pH modifiers such as citric acid, sodium citrate, succinic acid, phosphoric acid, sodium hydroxide and sodium carbonate; and preservatives such as benzyl alcohol, methyl paraben and propyl paraben.

Furthermore, as alluded to above, such a fluidized polymer dispersion has proven effective as an additive within paint formulations, particularly water-based types. The rheological benefits accorded such formulations by, for example, carboxymethylcellulose, is known; however, the ability to provide a dispersed version of such an effective additive permits greater versatility in the ability to incorporate such a component and target desired viscosity levels for improved spatter resistance, sagging, and leveling within the paint formulation for better application results.

Such paint formulations generally comprise at least the inventive fluidized polymer suspension and another active component that imparts the desired result to target painted substrates. Such another active component may include pigments, latexes, or other colorants; solvents to permit evaporation thereof after application to a suitable surface, and the like.

### PREFERRED EMBODIMENTS OF THE INVENTION

In general, samples were made with an addition sequence of:

| Addition | |
|---|---|
| Sequence | |
| 1 | Organic Carrier - Ex. Polyethylene glycol |
| 2 | Suspending Aid - Organoclay |
| 3 | Water |
| 4 | Surfactant or Lubricant for Increased Dissolution |
| 5 | Water Soluble Polymer - Ex. Carboxymethyl Cellulose |

All samples were made in a high-speed blender to give the high shear requirements needed by the organoclay to swell and interact. In general, 3 minutes of high shear mixing was given after the addition of the suspending aid and then 5 minutes of mixing after the water is added.

For the dissolution testing, 0.20 active parts of CMC (within the liquid suspension) was added to 100 parts of pigment. In all dissolution experiments, the pigment used was Huber Hydragloss® 90. The pigment was added to water to make a final suspension of 64% solids. After the liquid water-soluble polymer was mixed with the slurry for five to ten minutes, the material was screened through a 200 mesh screen, and pictures taken for the visual comparison.

### EXAMPLES 1 AND 2

An organoclay suspending aid (CLAYTONE APA®) was added to the low molecular weight polyethylene glycol and mixed under high shear for three minutes at about 30,000 rpm within a Waring blender. Afterwards, water was added and then all three ingredients were mixed for five minutes at about 15,000 rpm within the same mixer. Subsequently, a fine-grind medium-high molecular weight sodium carboxymethyl cellulose (FINNFIX® 4000 P from Noviant) was then incorporated at about 2,000 rpm within the same mixer for about 5-10 minutes. The amounts as added as measured per weight percent of the entire formulation are noted in the following table:

TABLE 1

| Example # | % PEG | % Clay | % Water | % CMC |
|---|---|---|---|---|
| 1 | 62% | 3% | 5% | 30% |
| 2 | 63% | 2% | 5% | 30% |

The Brookfield Viscosity of Example 1 was about 6400 (#5/20 rpm); this example exhibited very slight separation into phases after 30 days of storage under standard temperature and pressure. The BV of Example 2 was lower, about 3600, and this exhibited less stability, noticeable separation after 30 days, but very little after 7 days of storage. Compared with other types of fluidized polymers, however, such as REOMASTER® from Noviant, and others noted above (plus fatty acid salts, for instance), the stability of these two inventive dispersions was excellent, most notably for Example 1. Furthermore, Example 1 exhibited highly acceptable dissolution of a fine clay kaolin slurry for further application to paper during a coating procedure. Thus, such a fluidized polymer exhibited the properties necessary for reliable utilization within this industry and for such a delicate process.

### EXAMPLES 3-4

In these examples, a lubricant was added to the liquid CMC suspension, prior to introduction of the CMC itself, as noted within the table concerning additive sequences above, to observe its effect in increasing dissolution of the same fine kaolin clay slurry as was achieved for the dispersion of Example 1. The term Diss. Add. Means dissolution additive; in this instance CALSAN® 65, a lubricant available from BASF was used in this respect. Example 4 was a comparative example, being REOMASTER® from Noviant, which, instead of using a clay additive, utilized a dissolution additive, HYDROCARB® 90, from ??, at a 20% level. Example 3 included 2% of the CLAYTONE® APA self-activating clay.

TABLE 2

| Example # | % PEG | % Water | % Diss. Add. | % CMC |
|---|---|---|---|---|
| 3 | 58% | 5% | 5% | 30% |
| 4 | 40% | 0% | 20% | 40% |

The Brookfield Viscosity of Example 3 was about 5200, whereas the viscosity of Example 4 was much higher, about 9200. After 5 minutes of mixing with the fine kaolin clay slurry, Example 4 could not adequately dissolve such a composition. The inventive Example 3 visually dissolved the slurry without incident. After 10 minutes of high shear mixing (above 15,000 rpm), the same held true for both Examples. Thus, the inventive Example again exhibited excellent properties for utilization as an additive within a paper coating procedure, particularly by easily and effectively dissolving a pigment-based component without exhibiting any appreciable premature thickening through reaction with free water therein.

While the invention will be described and disclosed in connection with certain preferred embodiments and practices, it is in no way intended to limit the invention to those specific embodiments, rather it is intended to cover equivalent structures structural equivalents and all alternative embodiments and modifications as may be defined by the scope of the appended claims and equivalence thereto.

1. A fluidized polymer suspension comprising a water-soluble polymer, low molecular weight polyethylene glycol, a bentonite organoclay suspending aid, and, optionally, a dissolution additive.

2. The fluidized polymer suspension of claim 1 wherein the polyethylene glycol average molecular weight is less than about 600.

3. The fluidized polymer suspension of claim 1 wherein the polyethylene glycol average molecular weight is from about 200 to about 400.

4. The fluidized polymer suspension of claim 1 wherein the bentonite organoclay suspending aid is considered a self-activating bentonite organoclay.

5. (canceled)

6. The fluidized polymer suspension of claim 1 containing approximately 20 to 80% by weight of low molecular weight polyethylene glycol, from about 20 to 80% by weight of water soluble polymer, from 0.001 to 5% by weight of a dissolution additive, and from 0.5 to 5% by weight of a self activating bentonite organoclay.

7. The fluidized polymer suspension of claim 6 further contains 1 to 5% by weight of water.

8. The fluidized polymer suspension of claim 6 further contains 1 to 20% by weight of a C₁₂-C₂₄ fatty acid salt.

9. The fluidized polymer suspension of claim 8 wherein the fatty acid salt is selected from the group consisting of calcium stearate, magnesium stearate, sodium stearate, lithium stearate, barium stearate, zinc stearate, or aluminum stearate, and any mixtures thereof.

10. The fluidized polymer suspension of claim 1 where part of the polyethylene glycol is substituted for either by mineral oil, lubricant, calcium carbonate pigment, or kaolin pigment.

11. The fluidized polymer suspension of claim 6 further containing an additive selected from the group consisting of at least one surfactant, at least one crosslinker, at least one optical brightener, and any combination thereof.

12. A fluidized polymer suspension as defined in claim 1 where the said water-soluble polymer is selected from the group consisting of sodium carboxymethyl cellulose (CMC), hydroxyethyl cellulose (HEC), ethyl hydroxyethyl cellulose (EHEC) carboxymethylhydroxyethyl cellulose (CMHEC), hydrophobically modified hydroxyethyl cellulose (HMHEC), methyl cellulose (MC), and hydroxypropyl methyl cellulose (HPMC), guar, hydroxypropyl guar, xanthan gum, carrageenan, gum arabic, alginates, pectin, alginate, and tara gum.

13. (canceled)

14. A fluidized polymer suspension comprising a water-soluble polymer, low molecular weight polyethylene glycol, an organoclay suspending aid, and, optionally, a dissolution additive; wherein said fluidized polymer comprises at most 5% by weight of water.

15. The fluidized polymer suspension of claim 14 wherein the polyethylene glycol average molecular weight is less than about 600.

16. The fluidized polymer suspension of claim 15 wherein the polyethylene glycol average molecular weight is from about 200 to about 400.

17. The fluidized polymer suspension of claim 14 wherein the organoclay suspending aid is considered a self-activating organoclay.

18. The fluidized polymer suspension of claim 17 containing approximately 20 to 80% by weight of low molecular weight polyethylene glycol, from about 20 to 80% by weight weight of water-soluble polymer, from 0.001 to 5% by weight of a dissolution additive, and from 0.5 to 5% by weight of a self activating organoclay.

19. The fluidized polymer suspension of claim 18 further comprising from 1 to 20% by weight of a C₁₂-C₂₄ fatty acid salt.

20. The fluidized polymer suspension of claim 19 wherein the fatty acid salt is selected from the group consisting of calcium stearate, magnesium stearate, sodium stearate, lithium stearate, barium stearate, zinc stearate, or aluminum stearate, and any mixtures thereof.

21. A fluidized polymer suspension as defined in claim 14 where the said water-soluble polymer is selected from the group consisting of sodium carboxymethyl cellulose (CMC), hydroxyethyl cellulose (HEC), ethyl hydroxyethyl cellulose (EHEC) carboxymethylhydroxyethyl cellulose (CMHEC), hydrophobically modified hydroxyethyl cellulose (HMHEC), methyl cellulose (MC), hydroxypropyl methyl cellulose (HPMC), guar, hydroxypropyl guar, xanthan gum, carrageenan, gum arabic, alginates, pectin, alginate, and tara gum.
